(19) United States
(12) Patent Application Publication
(10) Pub. No.: US 2007/0089382 A1
(43) Pub. Date: Apr. 26, 2007

(54) Reciprocating Compressor and Filter Therefor

(75) Inventors: Haruo Miura, Kasumigaura (JP); Shigeru Arai, Tsuchiura (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Plant Technologies, Ltd., Chiyoda-ku (JP)

(21) Appl. No.: 11/552,665

(22) Filed: Oct. 25, 2006

(30) Foreign Application Priority Data
Oct. 26, 2005 (JP) 2005-310640

(51) Int. Cl. B01D 50/00

(52) U.S. Cl. 55/385.1

(57) ABSTRACT

A reciprocating compressor has a plurality of compressor stages each compressing a working gas by combining a cylinder and a plunger, and its discharge pressure exceeds 40 MPa. The compressor stage has a packing seal which seals a shaft of the plunger, and oil pouring means which pours a lubricating oil to the packing seal. A filter removes the lubricating oil poured by the oil pouring means from the working gas. In the filter, a first element using micro glass fiber and a second element using functional activated carbon are coaxially mounted. These two elements are included together in a pressure container. According to the above described construction, in the compressor at a high pressure exceeding 40 MPa, quality of the discharge gas can be kept and the compressor can be made compact.

### BACKGROUND OF THE INVENTION

(1) Field of the Invention

The present invention relates to a reciprocating compressor processing handling a flammable gas and a toxic gas, and particularly relates to a reciprocating compressor preferable for compression of hydrogen of a small capacity at a high pressure exceeding 40 MPa, and a filter therefor.

(2) Description of Related Art

In order to prevent a lubricating oil from entering a process line, use of a diaphragm compressor disclosed in “Diaphragm compressor”, Catalogue of Teisan Ltd., June, 1982 as a compressor for compressing a gas which is to be processed is known. It is possible to use such a diaphragm compressor as a hydrogen gas compressor for a fuel cell electric vehicle in the case of a small flow rate at a discharge pressure up to about 35 MPa. In the diaphragm compressor, a gas in a compression part is partitioned with a membranous diaphragm, and the gas is compressed by deforming the diaphragm, and the gas which is to be processed is not in contact with a lubricating oil and becomes completely oil free.

In the specification of a higher discharge pressure, plunger type compressors are in use in many cases instead of diaphragm compressors. An example of such a compressor is disclosed in JP-A-2004-116329. In JP-A-2004-116329, a plunger type hydrogen compressor is used as the hydrogen compressor which compresses hydrogen for use in a fuel cell electric vehicle, and compresses hydrogen to 80 MPa or more. Subsequently, the hydrogen gas after compressed is filtered with the three-stage filter to remove impurities such as a lubricating oil from the compressed gas.

In the apparatus using the diaphragm compressor as disclosed in “Diaphragm compressor”, Catalogue of Teisan, Ltd., June, 1982, purity of the gas is kept favorable. However, the diaphragm repeats elastic deformation, and therefore, there is the fear of the diaphragm deteriorating and breaking. Even if it does not break, the service life is limited by repetition of elastic deformation, and regular replacement of the compressor is required, which leads to extremely high maintenance expenses of the compressor.

Meanwhile, in the compressor disclosed in the above described JP-A-2004-116329, the three-stage filter is provided after the compressor stage to keep purity of a gas, and therefore, it is possible to provide a compressor with high purity of the discharge gas with long service life by utilizing the characteristics of the plunger type and the characteristics of the filter. However, since the high-pressure gas is filtered, the pressure resistance of the filter has to be extremely high, and the filter becomes expensive. In addition, the expensive filter is used in three stages, and therefore, reduction in the number of stages is desired.

The present invention is made in view of the problems of the above described prior arts, and has its object to keep the quality of a discharge gas and make a compressor compact in the compressor at a high pressure exceeding 40 MPa. Another object of the present invention is to realize a compact compressor with high reliability, which is capable of supplying a high-pressure hydrogen gas for use in a fuel cell electric vehicle.

### BRIEF SUMMARY OF THE INVENTION

The characteristic of the present invention which achieves the above described objects is that in a reciprocating compressor having a plurality of compressor stages each compressing a working gas by combining a cylinder, and a plunger or a piston, the compressor stage has a packing seal which seals a shaft of the plunger, and oil pouring means which pours a lubricating oil to the packing seal, a filter which removes the lubricating oil poured by the oil pouring means from the working gas is provided, and the filter has first filter means in which a first element using micro glass fiber, and a second element with a larger diameter than the first element are coaxially mounted and included inside a pressure container.

In this characteristic, the filter preferably has second filter means in which a third element using functional activated carbon is housed in a pressure container, in addition to the first filter means. The second filter means is preferably disposed at a downstream side from the first filter means. The filter may have a filter lid having an outlet and inlet passages, and hold a third element by sandwiching it between the first and second elements.

Another characteristic of the present invention which achieves the above described objects is a filter used in a reciprocating compressor with a discharge pressure exceeding 40 MPa, having first filter means having a first element using micro glass fiber, and second filter means having a second element using micro glass fiber, and these filter means are coaxially mounted. In this characteristic, the first and second filter means, and a third element using functional activated carbon are housed in the same pressure container, and the third element is preferably held by being sandwiched between a filter lid having an outlet and inlet passages and the first and second elements.

In the first filter means, a substantially plate-shaped filter lid and a filter bottle having a hollow part may be fastened by flange connection, a fixing bolt having a long shaft may be mounted in the filter lid, a partition tube may be placed around the fixing bolt so that a working gas can flow in a peripheral portion of the fixing bolt, a disk-shaped partition plate may partition the first and second elements, and the third element, a hole through which the fixing bolt penetrates may be formed in a central portion of the partition plate, a lower receiving seat which holds and sandwiches the first element with the partition plate, and an upper receiving seat which holds and sandwiches the second element with the partition plate may be provided, holes through which the fixing bolt penetrates may be formed in these upper receiving seat and lower receiving seat, a spring and a holding plate which holds the spring may be provided under the lower receiving seat, and after the fixing bolt penetrates through the first, second and third elements, the fixing bolt may be fastened with a fixing nut to hold the first, second and third elements.

Another characteristic of the present invention which achieves the above described object is that in a reciprocating compressor having a plurality of compressor stages and having a discharge pressure of 40 MPa or more, at least a final compressor stage includes a plunger having a packing seal portion, said reciprocating compressor further comprises means for pouring a lubricating oil to the packing seal portion, and a filter that removes the lubricating oil which gets mixed in the final compressor stage, the filter has one or more filter case constructed by a bottle case and a lid flange, an inlet passage and an outlet passage for a working gas are formed at the lid flange side, a filter element made of micro glass fiber and a filter element made of functional activated carbon are held in the bottle case.

In this characteristic, it is preferable that the filter element made of the micro glass fiber is disposed at a lower part, and the filter element made of the functional activated carbon is disposed at an upper part, and a partition plate partitions them. Guide means which guides the working gas so that the working gas flows into the filter element made of the functional activated carbon from the filter element made of the micro glass fiber is preferably disposed in the bottle case. The filter element made of the micro glass fiber is formed in multiple layers, and a gap is desirably formed between the layers. A filter case in which only a filter element made of the micro glass fiber is contained is preferably disposed at an upstream side of the filter case.

According to the present invention, since filtering of the three stages is made in the same container, even if the compressor at a high pressure exceeds 40 MPa, quality of the discharge gas is high and the compressor is made compact. Since the quality of the discharge gas is high, a high-pressure hydrogen gas for use in a fuel cell electric vehicle can be produced with the compressor.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a flow sheet of a plunger type hydrogen compressor according to the present invention;

FIG. 2 is a vertical sectional view of a second filter included in the compressor shown in FIG. 1; and

FIG. 3 is an enlarged view of element portions of the filter shown in FIG. 2.

### DETAILED DESCRIPTION OF THE INVENTION

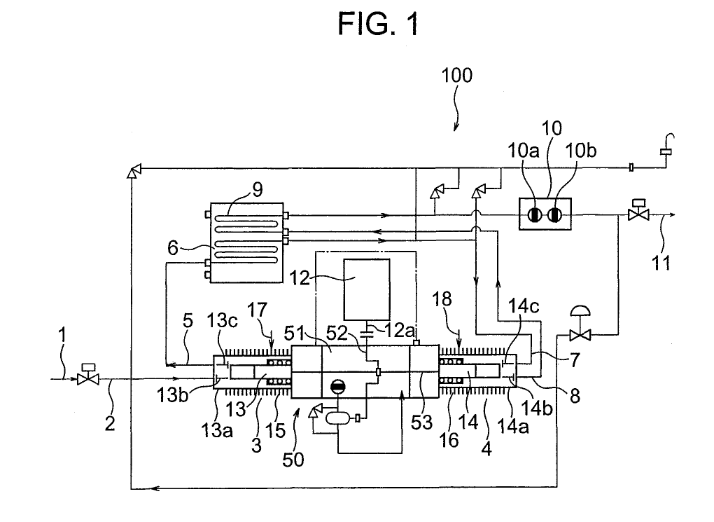

A compressor according to the present invention will be described by using the drawings. FIG. 1 is a flow sheet showing one embodiment of a plunger type small capacity high-pressure compressor system 100 including a gas filter which removes oil from a working gas, in a flow sheet. For a compressor body 50, two plunger type compressors are used for simplifying the explanation. A supply gas 1 which is supplied from gas supply equipment not shown flows into a first stage inlet line 2 of the compressor body 50.

In the compressor body 50, an output shaft 12a of a motor 12 is connected to a crankshaft 52 housed in a crankcase 51. One end side of the crank shaft 52 is rotatably mounted to a main shaft 53 in the crankcase 51. The main shaft 53 is capable of reciprocally moving in a horizontal direction. A plunger 13 constituting a first stage compressor 3 is mounted to one end of the main shaft 53, and a plunger 14 constituting a second stage compressor 4 is mounted to the other end of the main shaft 53.

The plunger 13 of the first stage compressor 3 forms a compression chamber defined between the plunger 13 itself and a casing 13a, and switches valves 13b and 13c provided near an inlet port and a discharge port to let a working gas flow into the compression chamber or discharge the working gas from the compression chamber. Similarly, the plunger 14 of the second stage compressor 4 has a compression chamber defined between the plunger 14 itself and a casing 14a, and switches valves 14b and 14c to let the working gas flow into the compression chamber or discharge the working gas from the compression chamber.

The working gas which is compressed in the first stage compressor 3 flows into an inter cooler 6 from a first discharge line 5. The working gas which is cooled by liquid or air in the inter cooler 6 flows into the second stage compressor 4 via a second stage inlet line 7. The working gas which is further increased in pressure in the second stage compressor 4 flows into an after-cooler 9 via a second stage discharge line 8, and is cooled by liquid or air. In this case, the inter cooler 6 and the after-cooler 9 are integrated. The working gas cooled in the after-cooler 9 is fed to a filter equipment 10, and has impurities removed from it. Thereafter, the working gas is fed to a consumer side through a delivery line 11 to a plant.

In the compressor body 50 of the compressor system 100 constructed as above, the plunger 13 of the first compressor 3 is sealed against gas leakage to an atmosphere side by a rod packing 15. Likewise, the plunger 14 of the second stage compressor 4 is sealed against gas leakage to the atmosphere side by a rod packing 16. Further, a very small amount of seal oil is poured to the rod packings 15 and 16 of the first stage compressor 3 and the second stage compressor 4 through lubrication holes 17 and 18 formed in the casings 13a and 14a. Part of the poured seal oil enters the working gas. Thus, the filter equipment 10 is provided at an outlet port side of the compressor body 50 so that the oil mixing amount is at an allowable value or less.

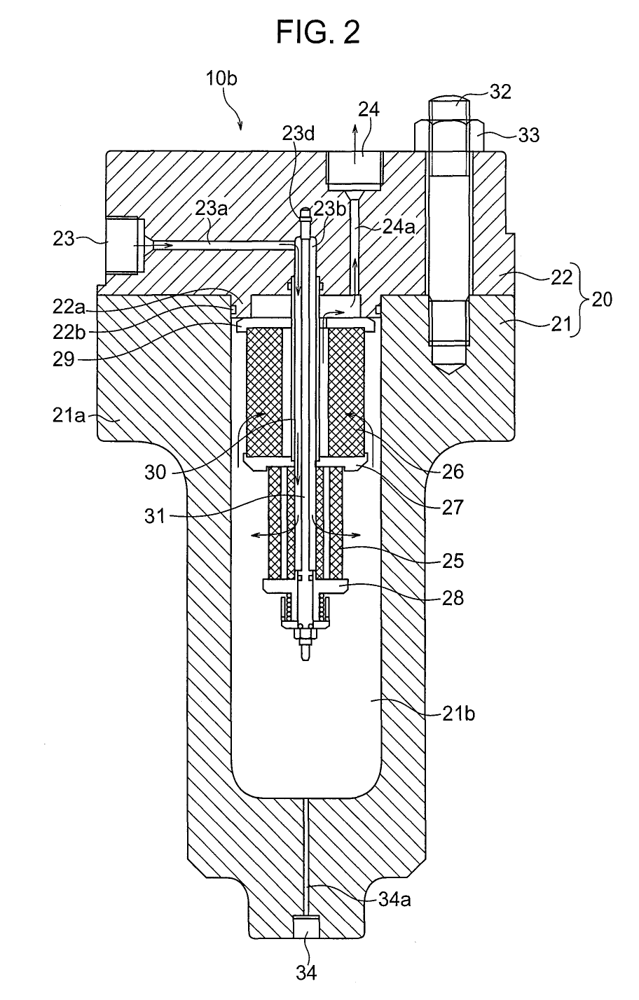

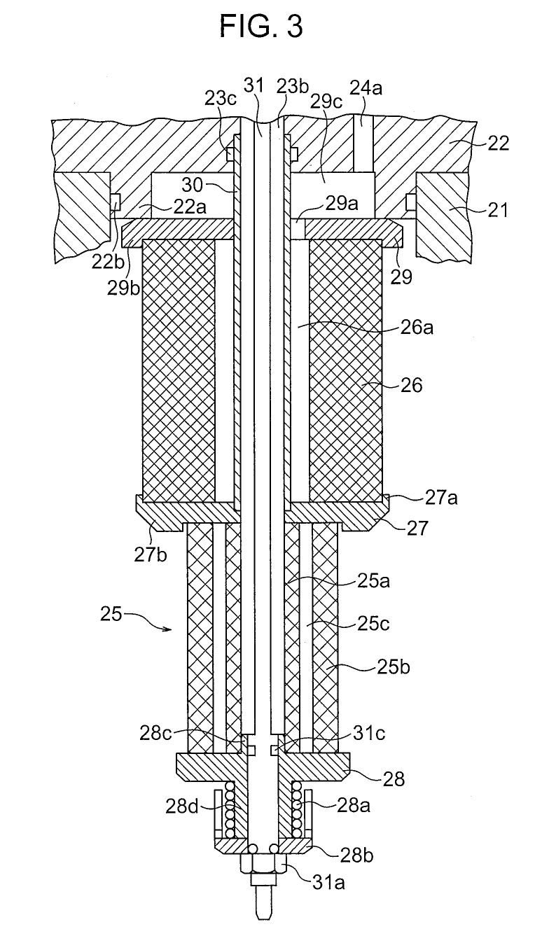

The detail of the filter equipment 10 will be described by using FIGS. 2 and 3. The filter equipment 10 has a first filter 10a and a second filter 10b, and FIG. 2 shows one example of the second filter. FIG. 3 is an enlarged view of a filter element part of the second filter 10b shown in FIG. 2.

The second filter 10b has a filter case 20 housing the filter element. The filter case 20 has a bottle case 21 and a flange lid 22. The bottle case 21 is a cylindrical container extending downward with a flange 21a formed at an upper portion. The flange lid 22 has a projection 22a that is fitted to the flange 21a of the bottle case 21. The bottle case 21 and the flange lid 22 are fastened with a plurality of bolts 32 provided at an outer peripheral portion with a space left from one another in a circumferential direction. With this, an O-ring 22b housed in a groove formed in the projection 22a prevents the working gas from leaking outside the second filter 10b from a space 21b in the bottle case 21.

In the flange lid 22 positioned at upper portion of the filter case 20, an inlet passage 23a for a gas, which extends in the horizontal direction to a substantially central portion, is formed and a discharge passage 24a, which is a through-hole extending vertically, is formed at a position out of the central portion. The inlet passage 23a has an opening 23 in a side surface of the flange lid 22, and a thread is formed in the opening 23 to be capable of connecting a pipe. Likewise, the outlet passage 24a has an opening 24 in a top surface of the flange lid 22, and a thread is formed in the opening 24 to be capable of connecting a pipe. A second inlet passage 23b that is a blind hole which is opened to the bottom surface side is connected to an end portion of the inlet passage 23a at a side of the central portion of the flange lid 22.

A threaded hole 23d is formed in the second inlet passage 23b, at the side of the connecting portion to the inlet passage 23a, and one end portion of a stepped fixing bolt 31 is screwed into the threaded hole 23d. The open side of the second inlet passage 23b is formed to be stepped, and a partition tube 30 is fitted to the stepped part. The partition tube 30 prevents a discharge gas of the compressor body 50 which flows into the filter element part from the opening 23, and a normal gas filtered in the filter element part from mixing. A groove is formed in the flange lid 22, and an O-ring 23c which seals a space between the flange lid 22 and the partition tube 30 is fitted into the groove.

The filter element part has two kinds of elements 25 and 26. Two kinds of cylindrical elements 25 and 26 are disposed upper and below, and a partition plate 27 partitions them. The element 26 disposed at the upper side (downstream side) is a functional activated carbon element, and constitutes second filter means. The element 25 disposed at the lower side (upstream side) is a micro glass fiber element and constitutes first filter means. In order to hold the upper element 26 with the partition plate 27, an upper receiving seat 29 is caused to abut on an undersurface of the projection portion 22a of the flange lid 22. A cylindrical space 29c is formed between the upper receiving seat 29 and the flange lid 22, and the discharge passage 24a communicates with the space 29c.

An edge portion 29b projected downward is formed at an outer peripheral portion of the upper receiving seat 29, and a through-hole in which the fixing bolt 31 and the partition tube 30 are inserted is formed in a central portion of the upper receiving seat 29. Further, a connecting hole 29a which continues to the through-hole to guide the working gas to the space 29c is formed in the upper receiving seat 29. An upper end portion of the upper element 26 is held with the edge portion 29b as a guide. A cylindrical space 26a is formed between the upper element 26 and the partition tube 30 to form a discharge passage of the working gas filtered by the upper filter 26.

A stepped hole is formed in a central portion of the partition plate 27, and a lower end of the partition tube 30 is fitted to a stepped portion of the stepped hole. An edge portion 27a projected upward is formed at an outer peripheral portion of the top surface of the partition plate 27. The upper element 26 has its lower end portion guided and held by the edge portion 27a. A step 27b is formed at the undersurface side of the partition plate 27 and at the position of the smaller diameter than the diameter of the edge portion 27a. The lower element 25 is constructed by inner and outer double cylinders, that is to say, an inner element 25a and an outer element 25b. An upper end portion of the outer element 25b is held by the step 27b portion. A gap is formed between the inner element 25a and the outer element 25b.

In order to hold a lower end portion of the lower element 25, a lower receiving seat 28 is fitted to the stepped portion of the fixing bolt. Projection portions 28c and 28d are formed on both upper and lower surfaces of a central portion of the lower receiving seat. The upper projection portion 28c is used as a guide when a lower end portion of the inner element 25a is held at an inner peripheral side thereof. Likewise, the lower projection portion 28d is used as a guide for holding a coil spring 28a.

After the coil spring 28a is disposed on the lower projection portion 28d as a guide, a lower end portion of the coil spring 28a is pressed with a spring seat 28b, and a nut 31a is screwed into a threaded portion formed at a lower end portion of the fixing bolt 31. A space between the lower receiving plate 28 and the fixing bolt 31 are sealed with an O-ring 31c. After the respective elements 25 and 26 are mounted by using the step portion and the projection portion as the guides, the nut 31a is fastened. Thereby, tension acts on the fixing bolt 31, so that the lower element 25 is held by being sandwiched by the lower receiving seat 28 and the partition plate 27, and the upper element 26 is held by being sandwiched by the partition plate 27 and the upper receiving seat 29.

In the second filter 10b constructed as above, the working gas, which is discharged from the compressor body 50 and cooled in the after-cooler 9, flows as the arrows shown in FIG. 2. Namely, the working gas which flows into the inlet flow passage 23a flows downward along an outer peripheral surface of the fixing bolt 31 inside the second inlet passage 23b. Then, the working gas flows further downward in the gap between the partition tube 30 and the fixing bolt 31 and reaches an inner peripheral portion of the micro glass fiber element 25 that is the first filter means.

The working gas which flows into the inner peripheral side of the inner micro glass fiber element 25a changes the flow direction from the axial direction to the radial direction, and passes from the inside to the outside of the lower element 25, in the sequence of the inner element 25a, a cylindrical space 25c and the outer element 25b. On that occasion, oil is removed, and stored in the bottom portion of the bottle case 21. Namely, the micro glass fiber element 25 does not accumulate oil inside, and therefore, oil in a molecular or mist form is liquefied, and drops to the bottom portion of the bottle case 21 from the outer peripheral surface of the lower element 25.

By making the lower element 25 have double layers, the following advantages are obtained as compared with the case of a single layer. The oil which is captured by the inner element 25a gathers at a lower side along the outer peripheral surface of the inner element 25a. As a result, the working gas having decreased oil flows into the outer element 25b. Since the cylindrical space 25c is formed between the two elements 25a and 25b, the flow rate of a gas flowing into the outer element 25b is made uniform in this space 25c. Oil removing performance is enhanced more than use of single thick element.

The working gas which passes through the lower element 25 changes the flow direction in the bottle case 21, temporarily rises to be an inward flow in the radial direction, and thereafter flows inside from the outer periphery of the functional activated carbon element 26 that is the second filter means. Oil is further removed when the working gas passes through the upper element 26. The cylindrical space 26a is formed between the inner periphery of the element 26 and the outer periphery of the partition tube 30, and the space 26a communicates with the upper cylindrical space 29c via the communication hole 29a. Therefore, the working gas is guided to the outlet hole 24 from the discharge passage 24a formed in the flange lid 22 and flows outside.

The details are omitted in this embodiment, but in the first filter 10a, the same element as the micro glass fiber element 25 shown in FIG. 2 is incorporated. The element in the first filter 10a and the micro glass fiber element 25 in the second filter 10b perform oil removing action as the primary and secondary filters, and the activated carbon element 26 acts as the tertiary filter.

Accordingly, before the working gas flows into the tertiary filter, oil is already removed from the working gas with the primary and the secondary micro glass fiber elements, and therefore, the oil in the working gas can be minimized. An activated carbon captures oil inside its cells, and therefore, has a limited life. However, since in this embodiment, the primary and the secondary micro glass fiber filters are provided as the previous stage of the activated carbon filter 26, and oil is minimized in advance, the life of the activated carbon filter before replacement can be made long. Alternatively, if the filter is produced on the basis of the required removal oil amount, the required activated carbon capacity can be made small, and the filter can be made compact. Since the micro glass fiber elements of the primary and secondary filters do not accumulate oil, elements do not require replacement and are semipermanently usable. As a result, the life of the filter 10 is extended and its reliability is enhanced.

This embodiment requires only two filter cases which are the high-pressure containers, and therefore, manufacturing cost of the compressor equipment can be reduced, which is economical. The first filter case can be used both as a snubber at the final stage of the compressor. In this case, the number of high-pressure containers can be further reduced, which is economical. The micro glass fiber used as the primary and the secondary filters in the above described embodiment is a coalescing element made of micro glass fiber bound with a fluorocarbon resin. This filter element and the functional activated carbon element as the tertiary element are used, and the secondary filter element and the tertiary filter element are housed in the same case. Therefore, oil mixing into the working gas can be removed to the minimum amount allowable in the process, for example, 1 ppm or less.

As described above, according to this embodiment, in the hydrogen compressor which has the discharge pressure at a high pressure of 40 MPa or more and hates oil, even if a very small amount of seal oil is poured and used to secure the sealing property of the rod packing portion, the filter reliably removes oil from the working gas with long service life, and therefore, reliability of the plunger type or piston type compressor and quality of the generated gas can be enhanced. In addition, the manufacturing cost of the compressor can be reduced.

It should be further understood by those skilled in the art that although the foregoing description has been made on embodiments of the invention, the invention is not limited thereto and various changes and modifications may be made without departing from the spirit of the invention and the scope of the appended claims.

1. A reciprocating compressor having a plurality of compressor stages each compressing a working gas by combining a cylinder, and a plunger or a piston,
wherein the compressor stage has a packing seal which seals a shaft of the plunger, and oil pouring means which pours lubricating oil to the packing seal,
a filter which removes the lubricating oil poured by the oil pouring means from the working gas is provided, and
the filter has first filter means in which a first element using micro glass fiber, and a second element with a larger diameter than the first element are coaxially mounted and included together inside a pressure container.

2. The reciprocating compressor according to claim 1,
wherein the filter has second filter means in which a third element using functional activated carbon is housed in a pressure container, in addition to the first filter means.

3. The reciprocating compressor according to claim 1,
wherein the second filter means is disposed at a downstream side from the first filter means.

4. The reciprocating compressor according to claim 1,
wherein the filter has a filter lid having an outlet and inlet passages, and holds a third element by sandwiching it between the first and second elements.

5. A filter used in a reciprocating compressor with a discharge pressure exceeding 40 MPa, comprising:
first filter means having a first element using micro glass fiber, and
second filter means having a second element using micro glass fiber,
wherein these filter means are coaxially mounted.

6. The filter used in a reciprocating compressor according to claim 5,
wherein the first and second filter means, and a third element using functional activated carbon are housed in the same pressure container, and the third element is held by being sandwiched between a filter lid having an outlet and inlet passages and the first and second elements.

7. The filter according to claim 6,
wherein in the first filter means, a substantially plate-shaped filter lid and a filter bottle having a hollow part are fastened by flange connection, a fixing bolt having a long shaft is mounted in the filter lid, a partition tube is placed around the fixing bolt so that a working gas can flow in a peripheral portion of the fixing bolt, a disk-shaped partition plate partitions the first and second elements, and the third element, a hole through which the fixing bolt penetrates is formed in a central portion of the partition plate, a lower receiving seat which holds and sandwiches the first element with the partition plate, and an upper receiving seat which holds and sandwiches the second element with the partition plate are provided, holes through which the fixing bolt penetrates are formed in these upper receiving seat and lower receiving seat, a spring and a holding plate which holds the spring are provided under the lower receiving seat, and after the fixing bolt penetrates through the first, second and third elements, the fixing bolt is fastened with a fixing nut to hold the first, second and third elements.

8. A reciprocating compressor having a plurality of compressor stages and having a discharge pressure of 40 MPa or more,
wherein at least a final compressor stage comprises a plunger having a packing seal portion, said reciprocating compressor further comprises means for pouring a lubricating oil to the packing seal portion and a filter that removes the lubricating oil which gets mixed in the final compressor stage,
wherein the filter has one or more filters case constructed by a bottle case and a lid flange, an inlet passage and an outlet passage for a working gas are formed at the lid flange side, and a filter element made of a micro glass fiber and a filter element made of functional activated carbon are held in the bottle case.

9. The reciprocating compressor according to claim 8,
wherein the filter element made of the micro glass fiber is disposed at a lower part, and the filter element made of the functional activated carbon is disposed at an upper part, and a partition plate partitions them.

10. The reciprocating compressor according to claim 9,
wherein guide means which guides the working gas so that the working gas flows into the filter element made of the functional activated carbon from the filter element made of the micro glass fiber is disposed in the bottle case.

11. The reciprocating compressor according to claim 9,
wherein the filter element made of the micro glass fiber is formed in multiple layers, and a gap is formed between the respective layers.

12. The reciprocating compressor according to claim 9,
wherein a filter case in which only a filter element made of the micro glass fiber is contained is disposed at an upstream side of the filter case.
